(19) United States
(12) Patent Application Publication
(10) Pub. No.: US 2025/0001885 A1
(43) Pub. Date: Jan. 2, 2025

(54) ELECTRICAL MACHINE UNIT, VEHICLE AND METHOD FOR OPERATING AN ELECTRICAL MACHINE UNIT

(71) Applicant: SEG Automotive Germany GmbH, Stuttgart (DE)

(72) Inventor: Nima SAADAT, Stuttgart (DE)

(21) Appl. No.: 18/749,993

(22) Filed: Jun. 21, 2024

(30) Foreign Application Priority Data
Jun. 27, 2023 (DE) 102023116904.1

(51) Int. Cl. B60L 53/22; B60L 53/24; H02K 7/00; H02K 11/00; H02K 11/21; H02K 11/33

(52) U.S. Cl. CPC B60L 53/22; B60L 53/24; H02K 7/006; H02K 11/0094; H02K 11/21; H02K 11/33; B60L 2210/30; B60L 2210/40

(57) ABSTRACT

An electrical machine unit includes an electrical machine and a power converter, the electrical machine having a plurality of regular phase windings and an additional inductance, the additional inductance being connected to at least one of the plurality of regular phase windings. The power converter includes a plurality of half-bridges, each of which is connected to one of the plurality of regular phase windings of the electrical machine, the electrical machine unit having DC voltage terminals (B+, B−) for connection to an energy storage (150) and DC side switches (180+, 180−), wherein DC side terminals (146+, 146−) of the plurality of half-bridges are each connected to each other and are each connectable to or disconnectable from a respective one of the DC voltage terminals via one of the DC side switches.

### CROSS-REFERENCE TO RELATED APPLICATIONS

This application claims priority to German Patent Application No. 102023116904.1 filed 27 Jun. 2023 which is hereby incorporated by reference in its entirety.

### TECHNICAL FIELD

The present invention relates to an electrical machine unit with an electrical machine and a power converter, a vehicle with such an electrical machine unit and a method for operating such an electrical machine unit.

### BACKGROUND

In electrical machines, particularly those used as motors and/or generators, and especially when used in vehicles, inverters (power converters) are used to rectify the alternating current generated or to alternate the direct current applied. In particular, an energy storage such as a battery is also provided for this purpose, which can be charged or from which energy can be drawn to operate the electrical machine. In particular, if an electrical machine is (also) used as a traction drive for a vehicle, it is usually necessary to be able to charge the energy storage externally, e.g. from a (public or private) power grid.

### SUMMARY

According to the invention, an electrical machine unit, a vehicle and a method for operating an electrical machine unit with the features of the independent claims are proposed. Advantageous embodiments are the subject of the dependent claims and the following description.

The invention relates to electrical machines and associated power converters or inverters and their operation. In the context of the invention, the combination of electrical machine and associated power converter should also be referred to as an electrical machine unit. Typically, the power converter is attached or mounted to the electrical machine. The electrical machine unit can be part of a vehicle, in particular also be used as a traction drive. Possible electrical machines include synchronous machines, synchronous reluctance machines, induction machines, permanent magnet machines and others. The power converter and the electrical machine or electrical machine unit and their operation will be described together below.

Typical electrical machines have, for example, three phases or a multiple thereof; although the explanation of the present invention is given primarily with reference to electrical machines with three phases, this also applies to a different number of phases, for example six, nine, twelve or 15 phases. Typically, three phases form a group (phase group). The electrical machine has one phase winding per phase (however, phase and phase winding are often used interchangeably).

The several phase windings of the electrical machine, possibly also per group, can also be interconnected, e.g. in a star or delta connection. In the case of a star connection, there is a so-called neutral point to which all phase windings are connected. The phase windings are inserted into a stator of the electrical machine (thus forming a stator winding). In principle, however, the electrical machine can also have only one or two phases.

The electric machine also has a rotor that can be permanently and/or externally excited. A preferred use is also in so-called high-voltage applications, in which the electrical machine is operated with a voltage of 48 V, 60 V or higher, for example.

The power converter has several half bridges, typically one half bridge per phase of the electrical machine, i.e. the power converter is thus designed for a certain number of phases of the electrical machine with which it is to be used. For this purpose, the power converter can have several phase connections, to each of which one of the several phase windings of the electrical machine is to be connected. In general, each of the multiple half-bridges is or will be connected to one of the multiple phase windings of the electrical machine at a center tap of the respective half-bridge.

A half-bridge in turn comprises two switches or switching elements (e.g. MOSFETs or IGBTs) whose center tap (tap between the two switches) is to be connected to the associated phase connection as mentioned. The other two connections-the DC side connections-of the half bridges are typically connected together to one (positive or negative) DC voltage terminals each. The power converter or the electrical machine unit in general therefore has DC voltage terminals, which in turn are set up for connection to an energy storage such as a battery. Typically, a DC link capacitor is also provided between the DC voltage terminals. Such a power converter is preferably bidirectional, i.e. it can convert both DC voltage into AC voltage (for motor operation of the electrical machine) and vice versa (for regenerative and possibly recuperative operation of the electrical machine).

At this point, it should be mentioned that a connection or a link in the context of the present invention is to be understood in particular as an electrical or electrically conductive connection or an electrically conductive link.

Typically, the half bridges are electrically (directly) connected (via their center tap) to the associated phase connection and then to the associated phase. However, in order to be able to charge the energy storage device, which is located in a vehicle for example, from an external source—and not just via regenerative operation of the electrical machine—a connection option for an external voltage source can be provided. In principle, on-board (integrated in the vehicle) and off-board (provided separately from the vehicle) charging devices or chargers can be considered. On-board charging devices are preferred, particularly due to cost and weight savings.

As already mentioned at the beginning, if an electrical machine is (also) used as a traction drive for a vehicle, it is usually necessary to be able to charge the energy storage externally, e.g. from a (public or private) power grid or a charger, generally a power supply system.

The power flow of the power supply system can be either unidirectional or bidirectional. In modern applications, the bidirectional power supply system is usually preferred over unidirectional charging, as it offers the possibility of supporting the power supply system or the power grid with the stored energy from the battery. Feeding electricity from an electric vehicle (EV) battery into the grid (V2G) can improve grid stability, increase power quality and restore grid voltage in the event of grid faults.

However, one problem here, as has been turned out, is that the charging infrastructure available in different geographical locations can support different voltages. For example, some stationary charging stations may support 400 V DC and others 800 V DC.

Typical topologies for integrated chargers are usually suitable for connection to the AC grid, although there is often no option to connect them to the DC grid. Nowadays, the trend is to use 800 V nominal voltage for the battery and the power converter (inverter), as electric vehicles usually operate at 800 V nominal voltage. Therefore, a 400 V charging station cannot be used to charge 800 V electric vehicles.

One solution to this would be to replace any 400V charging stations with higher voltage charging stations, or to install an adapted DC-DC converter in the 400V charging stations to increase the 400V of the charging station to 800V, both of which lead to higher costs and large investments in available 400V charging stations.

In the context of the invention, however, a possibility is proposed to support different voltages of charging stations or power supply systems with an electrical machine unit.

It has also been found that the inductances of the phase windings may not be sufficient, as power converters often operate at low switching frequencies of less than 30 kHz, for example. Operating the power converter in DC-DC mode would therefore lead to a high DC input current.

Against this background, it is proposed that the electrical machine also has an additional inductance in addition to the several, e.g. three, phases, each with a phase winding. In particular, the additional inductance can also be a winding (additional winding), so that the phase windings of the phases of the electrical machine are to be referred to below as regular phase windings. While the multiple regular phase windings are connected to each other at a neutral point, the additional inductance is connected to at least one of the multiple regular phase windings.

In particular, exactly one additional inductance or additional winding is provided, i.e. a three-phase electrical machine then has a total of four windings (or winding strands). A 3n-phase electrical machine then has a total of 3n+1 windings (or winding strands).

While the power converter can basically be designed as explained above, the electrical machine unit has first DC charging terminals (typically two) and second DC charging terminals (also typically two).

The additional inductance is connected or can be connected to one of the first DC charging terminals, preferably the positive first DC charging terminal. This first DC charging terminal is thus connected via the additional inductance (via the neutral point) to one or more of the regular phase windings and then to the center taps of the half bridges. One side of the DC side terminals of the plurality of half bridges, typically the negative side, is connected or connectable to another of the first DC charging terminals.

The first DC charging terminals can, for example, each be connected to a corresponding charging contact in a charging socket or a charging interface of the vehicle in general. Similarly, the second DC charging terminals can, for example, each be connected to a corresponding charging contact in a (different) charging socket or generally a (different) charging interface of the vehicle.

In addition, the electrical machine unit, in particular the power converter, comprises DC side switches, which may be, for example, semiconductor switches such as MOSFETs or IGBTs, or also, for example, electro-mechanical switches. As mentioned, the DC side terminals of the multiple half-bridges are each connected to each other, but can also be connected or connectable to a respective one of the DC voltage terminals via one of the DC side switches in a closed state of the switches and disconnected or disconnectable from this, i.e. the respective one of the DC voltage terminals, in an open state of the switches.

In this way, the power converter can be used not only for regular operation of the electrical machine, i.e. in particular for motor and/or generator operation, but also for energy transfer between the energy storage device and an external DC voltage system, e.g. for charging the energy storage. Depending on the type of external DC voltage system or its voltage level, the energy storage can therefore be charged directly, for example, via a connection of the external DC voltage system to the second DC voltage charging terminals; this is useful, for example, if the external DC voltage system has the same or approximately the same voltage level as the energy storage, e.g. 800 V.

However, the energy storage device can also be charged via the additional inductance, at least one of the phase windings and the power converter by connecting the external DC voltage system to the first DC charging terminals; this is useful, for example, if the external DC voltage system has a different voltage level than the energy storage, e.g. 400 V for an energy storage with 800 V. The power converter or the relevant half bridges can then be used as boost converters. The power converter or the relevant half bridges can then be used as step-up converters. In principle, it is also possible to convert the voltage from a higher to a lower voltage level and also with different voltage levels. The power converter must be controlled accordingly for this purpose. In principle, an energy transfer without converting the voltage would also be conceivable here, e.g. for emergency operation.

While in the aforementioned operating modes the switches are closed, with the switches open, energy transfer is possible between two different external DC voltage systems, one of which is connected to the first and one to the second DC charging terminals. Here too, the two external DC voltage systems can have different voltage levels; it is also conceivable that both external DC voltage systems have the same or approximately the same voltage level, with the second external DC voltage system typically having a slightly higher voltage. Energy transfer is also possible in this case.

As already mentioned, the inductances of the phase windings may not be sufficient, as converters often operate at low switching frequencies of less than 30 kHz, for example. However, by using an additional inductor, the inductance can be adjusted. By arranging the additional inductance as part of the electrical machine, in particular the stator, an inductive (or generally electromagnetic) coupling of the additional inductance with at least one of the phase windings is achieved. Depending on requirements, the additional inductance can be arranged in a suitable manner in order to achieve a stronger or lower inductive coupling. The additional inductance can be directly inductively coupled to at least one of the several regular phase windings, but the additional inductance can also be inversely inductively coupled to at least one of the several regular phase windings. For example, the additional inductance can be designed as an additional winding and arranged in the stator in the same way as the multiple regular phase windings.

This type of coupled additional inductance is particularly effective in reducing interfering current ripples. The arrangement of the additional inductance in the electrical machine also makes the entire system more compact and eliminates the need for external access to the neutral point of the electrical machine.

In one embodiment, the additional inductance is connected to the neutral point and via it to the plurality of regular phase windings. In another embodiment, the additional inductance is connected to one of the plurality of regular phase windings on a side of this regular phase winding facing away from the neutral point. In this way, a total of three inductances, the additional inductance, one of the plurality of regular phase windings to which the additional inductance is connected and one of the other regular phase windings can be connected in series, which means that the additional inductance can be made smaller if necessary.

Another object of the invention is a vehicle with an electrical machine unit according to the invention. That can be used as a traction drive, but another use is also conceivable-with a smaller machine. In this case, the vehicle can then have charging contacts which are set up for connection to a counterpart, in particular a charging plug or a charging socket, in particular for two different DC voltages, in particular both at the same time, i.e. two charging sockets, for example.

Further advantages and embodiments of the invention are shown in the description and the accompanying drawing.

The invention is illustrated schematically in the drawing by means of embodiment examples and is described below with reference to the drawing.

### BRIEF DESCRIPTION OF THE DRAWINGS

FIG. 1 schematically shows a vehicle according to the invention in a preferred embodiment.

FIG. 2 schematically shows an electrical machine unit according to the invention in a preferred embodiment

FIGS. 3a, 3b, 3c schematically show parts of an electrical machine unit according to the invention in various preferred embodiments.

FIG. 4 shows the electrical machine unit from FIG. 2 in a different operating mode.

FIG. 5 shows the electrical machine unit from FIG. 2 in a different operating mode.

FIG. 6 shows the electrical machine unit from FIG. 2 in a different operating mode.

### DETAILED DESCRIPTION

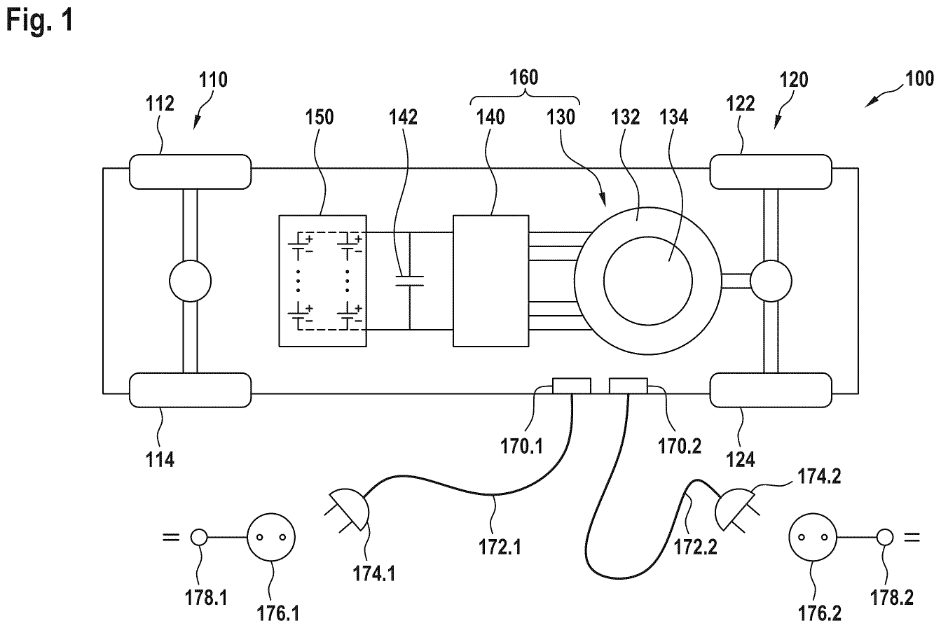

FIG. 1 roughly schematically illustrates a vehicle 100 according to the invention in a preferred embodiment. The vehicle 100 has a front axle 110 with wheels 112 and 114, and a rear axle 120 with wheels 122 and 124. The rear axle 120 is driven by means of an electric machine 130 with stator 132 and rotor 134. The electric machine 130 thus serves as a traction drive. It is understood that the front axle or both axles can also be driven.

The electrical machine 130 is connected to a power converter or inverter 140 (shown here only schematically, for a more detailed illustration please refer to the following Figs.). The power converter 140 is in turn connected, possibly via a DC link capacitor 142 (which can be part of the power converter 140), to an energy storage 150, such as a battery. DC voltage provided by the battery 150 can be converted into alternating voltage for motor operation of the electric machine 130 via the power converter 140. Conversely, AC voltage generated during generator operation of the electric machine 130 can also be converted into DC voltage via the (thus bidirectional) power converter 140 in order to charge the battery 150.

The electrical machine 130 and the power converter 140 are part of an electrical machine unit 160, as already mentioned at the beginning.

Furthermore, a first charging interface 170.1 is provided at the vehicle 100, namely a DC charging interface for DC voltage. The first charging interface 170.1 can be connected, for example, via a charging cable 172.1 with plug 174.1 and via a socket 176.1 to a DC voltage source 178.1, e.g. a power grid, an external power supply unit or another DC voltage system. In this way, the energy storage or battery 150 can be charged. It should be noted that the specific connection of the DC charging interface 170.1 to the electrical machine unit 160 or the battery 150 is not shown here; please refer to the following Figs.

Furthermore, a second charging interface 170.2 is provided at the vehicle 100, which is also a DC charging interface. The second charging interface 170.2 can be connected, for example, via a charging cable 172.2 with plug 174.2 and via a socket 176.2 to a DC voltage source 178.2, e.g. a power grid, an external power supply unit or another DC voltage system. In this way, the energy storage device or battery 150 can be charged. It should be noted that the specific wiring of the DC charging interface 170.2 with the electrical machine unit 160 or the battery 150 is not shown here; please refer to the following Figs.

As will be explained in more detail below, the first charging interface 170.1 and the second charging interface 170.2 are provided in particular for different voltage levels of the respective DC voltage source to be connected, e.g. 400 V and 800 V.

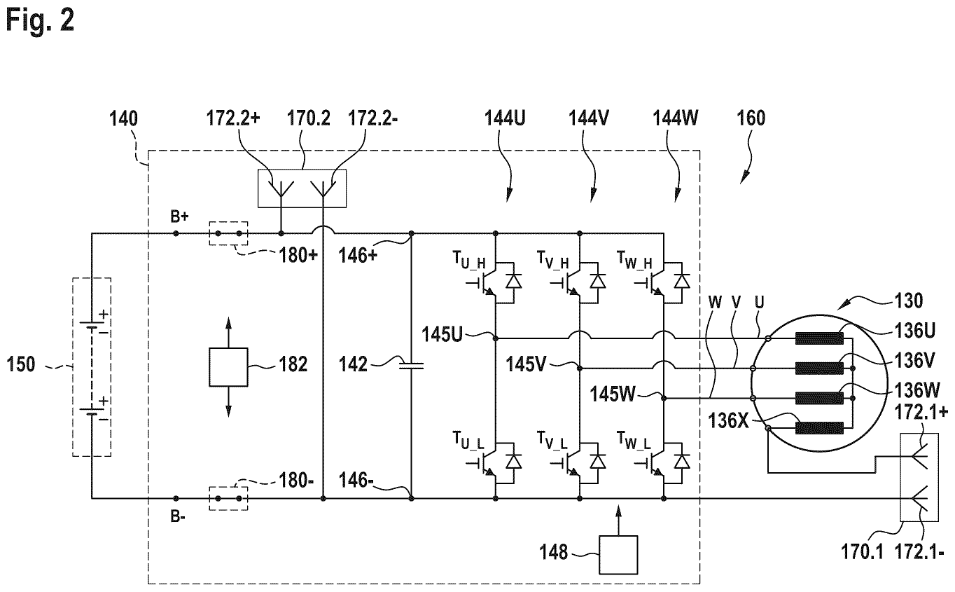

FIG. 2 schematically illustrates an electrical machine unit 160 according to the invention in a preferred embodiment; this may be the electrical machine unit 160 from FIG. 1. In addition, the power converter 140 and the battery 150 are shown, which may also be those shown in FIG. 1. The power converter 140 may be a power converter according to the invention in a preferred embodiment.

Three phases U, V and W are shown for the electrical machine 130, each comprising a phase winding 136U, 136V, 136W. It should be noted that the terms phase and phase winding can also be used synonymously, whereby phase winding usually (only) refers to the winding or coil within the stator. The phase windings 136U, 136V, 136W are part of the stator (see FIG. 1); the rotor is not shown here. The phase windings 136U, 136V, 136W are also (electrically) connected to each other at a neutral point 138; this may be a so-called star connection.

In addition, the electrical machine 130 has an additional inductance 136X in the form of an additional winding. For better differentiation from the additional winding 136X, the phase windings 136U, 136V, 136W will also be referred to as regular phase windings. The regular phase windings 136U, 136V, 136W and the additional inductance or additional winding 136X can in particular be arranged in the stator, i.e. the regular phase windings 136U, 136V, 136W and the additional winding 136X can be wound in the same way on stator teeth.

Due to the arrangement of the additional winding, together with the regular phase windings 136U, 136V, 136W, in the electrical machine 130, in particular in its stator, a particularly good inductive (or electromagnetic) coupling between the additional winding and the regular phase windings is possible. The additional winding 136X, like the regular phase windings 136U, 136V, 136W, can have a connection (phase connection) to the electrical machine.

In the electrical machine 130, the additional winding 136X is here exemplarily (directly) connected to the neutral point 138 and via it to the regular phase windings 136U, 136V, 136W (of the same type).

In the example shown, the wiring is such that the additional winding 136X is directly inductively coupled to the regular phase windings 136U, 136V, 136W. This is illustrated by the dots on the regular phase windings 136U, 136V, 136W and the additional winding 136X.

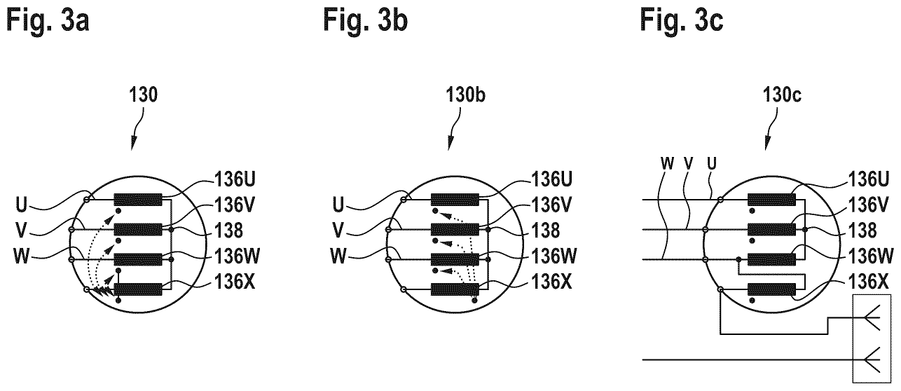

In FIG. 3a, the electrical machine 130 from FIG. 2 is shown again, with the inductive (or electromagnetic) coupling between the additional winding and the regular phase windings indicated by arrows.

FIG. 3b shows an electrical machine 130b, which can basically correspond to the electrical machine 130 of FIG. 2 or 3a, but the additional winding 136X is inversely (or indirectly) inductively coupled to the regular phase windings 136U, 136V, 136W. This is illustrated by the dots on the regular phase windings 136U, 136V, 136W and the additional winding 136X. The individual windings can be connected differently for this purpose.

In FIG. 3c, an electrical machine 130c is shown, which basically corresponds to the electrical machine 130 of FIG. 2 or 3a, but the additional winding 136X is connected to the regular phase windings 136W on a side of this regular phase winding 136W facing away from the neutral point 138. In this way, the additional winding 136X is connected in series with the regular phase windings 136W and is then connected via the neutral point 138 to the two other regular phase windings 136U, 136V.

The arrangement of the additional winding 136X and the regular phase windings 136U, 136V, 136W in the electrical machine or the stator can as such be the same as in FIG. 3a, 3b, but the wiring can be adapted accordingly.

In the electrical machine 130c, the additional winding 136X is directly inductively coupled to the regular phase windings 136U, 136V, and optionally also 136W, but inverse (indirect) inductive coupling could also be provided here. For example, the additional winding 136X may simply be connected in series with the regular phase winding 136W, resulting in no or negligible inductive coupling. Similarly, the additional winding 136X may also be specifically inductively coupled to the regular phase winding 136W (e.g. in addition to 136U, 136V).

The power converter 140, see again FIG. 2, has-for the three-phase electrical machine-six switches or switching elements, e.g. transistors such as MOSFETS or IGBTs, whereby two switches each form a half bridge and are assigned to one phase. Alternatively, half bridges with three or more levels can be used instead of such two-level half bridges. As an example, the switching elements for phase U are labeled T_{U_H} and T_{U_L} (highside and lowside), for phase V with T_{V_H} and T_{V_L} (highside and lowside), and for phase W with T_{W_H} and T_{W_L} (highside and lowside), whereby the two switching elements per phase form a half-bridge labelled 144U, 144V and 144W respectively. A center tap 145U, 145V, 145W of the half bridge can be connected to or is connectable to the relevant phase U, V, W or the corresponding phase winding 136U, 136V or 136W.

Furthermore, a control circuit 148 for the switches or switching elements of the half bridges is shown, e.g. a so-called gate driver circuit. That can control the switches or switching elements in a suitable manner for opening and closing in order to control the power converter for current conversion. The control circuit 148 can receive control signals, for example, from a motor control unit not shown here; it is also conceivable that the control circuit 148 is part of a motor control unit.

The DC side terminals of the half bridges 144U, 144V and 144W are each interconnected and labelled 146+ and 146− respectively. The DC side terminals can be connected to DC voltage terminals B+ or B− of the power converter. Two switches 180+ and 180− are provided for this purpose, whereby the DC side terminal 146+ is connected to the DC voltage terminals B+ via the switch 180+ when this is in a closed state. Correspondingly, the DC side terminal 146− is connected to the DC voltage terminals B− via the switch 180− when the latter is in a closed state. When the switches 180+ and 180− are in the open state, the DC side terminals 146+ and 146− are disconnected from the DC voltage terminals B+, B− accordingly.

The switches 180+, 180− can, for example, be controlled for opening and closing via a control circuit 182 of the power converter 140. The control circuit 182 can receive control signals, for example, from a motor control unit not shown here; it is also conceivable that the control circuit 148 is part of a motor control unit.

The aforementioned switches 180+, 180− can, for example, each be one or more transistors such as MOSFETs or IGBTs. Alternatively, the switches can also be designed as electromechanical switches, for example.

The DC link capacitor 142 is connected in parallel to the DC side terminals, and the power converter 140 is connected or can be connected to the energy storage or battery 150 via the DC voltage terminals B+ and B−.

Furthermore, the electrical machine unit 160 has two first DC charging terminals 172.1+, 172.1−. These can be connected to the first charging interface 170.1. As an example, the first charging interface 170.1 is shown in FIG. 2 at or near the first DC charging terminals 172.1+, 172.1− for easier assignment.

The additional winding 136X is exemplarily connected to the first DC charging terminal 172.1+, whereas the negative side 146− of the DC side terminals of the plurality of half-bridges is connected to the first DC charging terminal 172.1−.

Furthermore, the electrical machine unit 160 has two second DC charging terminals 172.2+, 172.2−. These can be connected to the second charging interface 170.2. As an example, the second charging interface 170.2 is shown in FIG. 2 at or near the second DC charging terminals 172.2+, 172.2− for easier assignment.

The DC side terminal 146+ of the multiple half bridges is connected to the second DC charging terminal 172.2+, and the DC side terminal 146− of the multiple half bridges is connected to the second DC charging terminal 172.2−. The connection of the second DC charging terminals is such that opening the switches 180+, 180− disconnects the second DC charging terminals from the DC voltage terminals B+, B−, but not from the DC side terminals 146+, 146− of the multiple half bridges. Furthermore, a protective device, in particular a mechanical protective device, can be provided, for example, which prevents an external DC voltage source from being connected to one of the charging terminals if necessary; this can be particularly useful during (motor or generator) operation of the electrical machine.

The first DC charging terminals 172.1+, 172.1− can be part of the power converter or integrated into it. It is to be ensured that one of the first two DC charging terminals is connected to the additional winding 136X. An additional electrical connection may therefore be required in addition to the electrical connections between the power converter and the regular phase windings.

The second DC charging terminals 172.2+, 172.2− can also be part of the power converter or integrated into it.

As can be seen from FIGS. 3b, 3c, the electrical machines 130b, 130c shown there could be replaced by the electrical machine 130 shown in FIG. 2. The external connections of the electrical machine for the power converter can be similar, only the internal wiring or, if applicable, the arrangement of the regular phase windings and the additional phase winding can be different.

Various operating modes are now possible with the electrical machine unit 160 shown in FIG. 2. With the situation shown in FIG. 2—the switches 180+, 180− are in a closed position—regular operation of the electrical machine 130, both motor and generator, is possible. The power converter 140 or the half bridges with their switches can be controlled in the usual way for the purpose of converting between DC and AC voltage.

Currents flow between the electrical machine and the power converter, as well as a current between the energy storage and the power converter. It is to be ensured that no external DC voltage system is connected to either the first DC voltage charging terminals or the second DC voltage charging terminals. The protective device already mentioned can be provided for this purpose, for example.

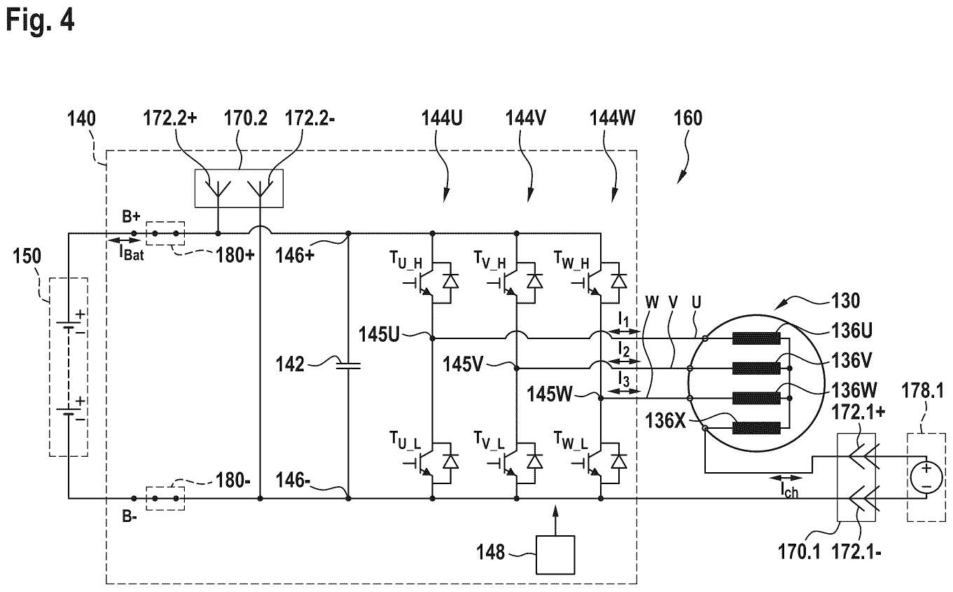

In FIG. 4, the electrical machine unit 160 of FIG. 2 is shown in a different operating mode, namely an energy transfer between the battery and an external DC voltage system such as the DC voltage source 178.1 connected to the first charging interface 170.1, e.g. an external charging of the battery 150. The electrical machine unit 160 corresponds to that of FIG. 2, so that not all components are designated or described again here; in this respect, reference can be made to FIG. 2 and the associated description.

The switches 180+, 180− are in the closed position. For this purpose, the power converter 140 or the half bridges with their switches can be controlled to convert a DC voltage between a first voltage level, which is provided by the first DC voltage source 178.1, i.e. between the first DC charging terminals, and a second voltage level of the energy storage device.

A current I_{ch} flows from the DC voltage source 178.1 via the additional winding, the neutral point and the regular phase windings to the half bridges. The current I_{ch} is divided into the individual currents I₁, I₂, I₃ in the phases. The voltage can be adjusted accordingly via suitable control of the half bridges or their switches, whereby a corresponding current I_{bat} flows to the battery 150.

The half bridges can therefore be controlled in such a way that they act as DC-DC converters to charge the battery 150 with a current I_{bat}. This means that a battery with 800 V can be charged with 400 V DC voltage, for example. Energy could also be transferred from the battery 150 to the DC voltage source 178.1. It should be noted that no external DC voltage system should be connected to the second DC voltage charging terminals.

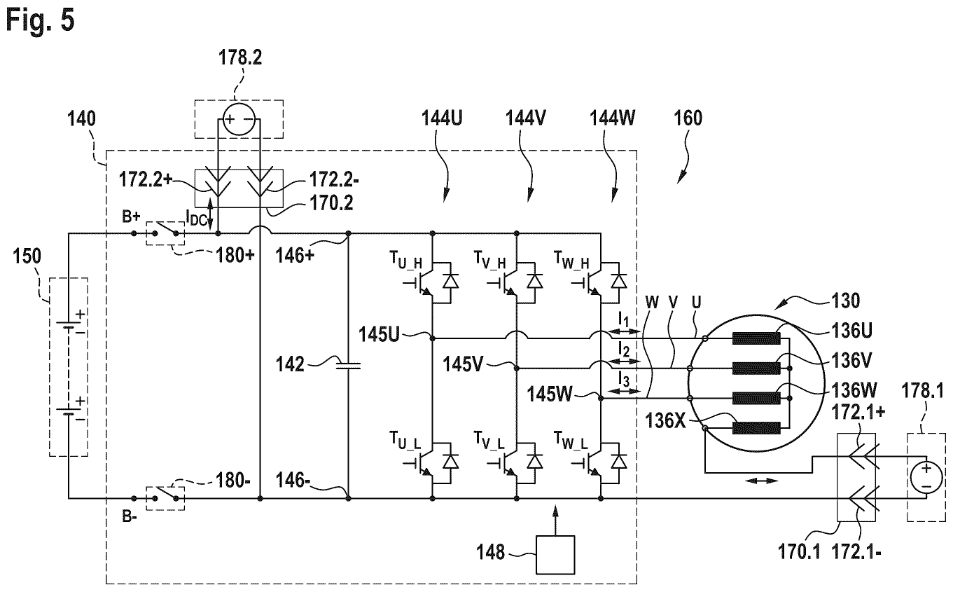

In FIG. 5, the electrical machine unit 160 of FIG. 2 is shown in a different operating mode, namely an energy transfer between a first external DC voltage system such as the DC voltage source 178.1, which is connected to the first charging interface 170.1, and a further external DC voltage system such as the DC voltage source 178.2, which is connected to the second charging interface 170.2. The electrical machine unit 160 corresponds to that shown in FIG. 2, so that not all components are designated or described again here; in this respect, reference can be made to FIG. 2 and the associated description.

The switches 180+, 180− are in the open position, so that the battery 150 is disconnected from the power converter 140. For this purpose, the power converter 140 or the half bridges with their switches can be controlled to convert a DC voltage between a first voltage level, which is provided by the first DC voltage source 178.1, i.e. between the first DC charging terminals, and a second voltage level, which is provided by the second DC voltage source 178.2, i.e. between the second DC charging terminals.

A current flows from the DC voltage source 178.1 via the additional winding, the neutral point and the regular phase windings to the half bridges. The current is divided into the individual currents I₁, I₂, I₃ in the phases. The voltage can be adjusted accordingly via suitable control of the half bridges or their switches, whereby a corresponding current I_{DC} flows to the DC voltage source 178.2.

The half bridges can therefore be controlled in such a way that they act as DC-DC converters to supply the DC voltage source 178.2 with a current I_{DC}. This means, for example, that 400 V DC voltage can be used to supply another DC voltage source with 800 V. Energy could also be transferred from the DC voltage source 178.2 to the DC voltage source 178.1.

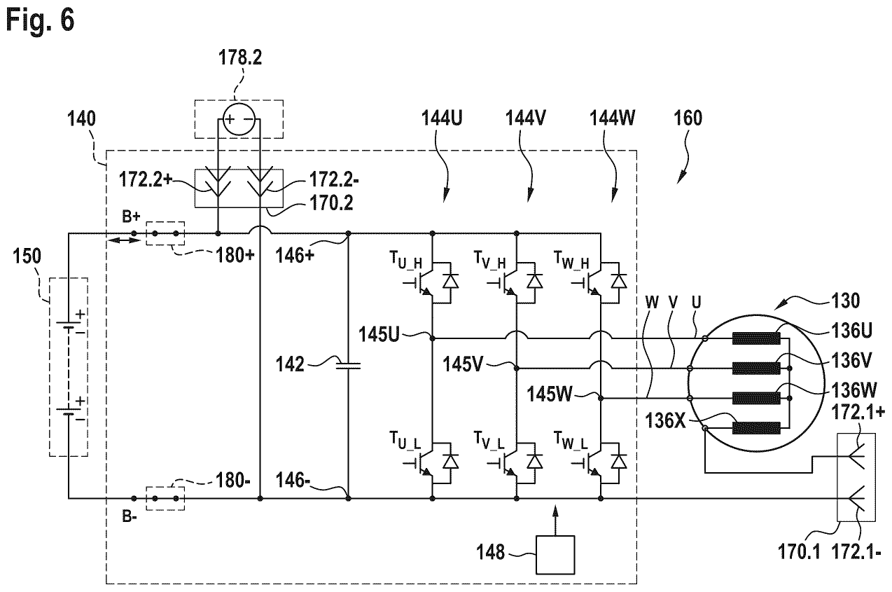

In FIG. 6, the electrical machine unit 160 of FIG. 2 is shown in another operating mode, namely an energy transfer between the battery and an external DC voltage system such as the DC voltage source 178.2, which is connected to the second charging interface 170.2, e.g. an external charging of the battery 150. The electrical machine unit 160 corresponds to that of FIG. 2, so that not all components are designated or described again here; in this respect, reference can be made to FIG. 2 and the associated description.

The switches 180+, 180− are in the closed position. The power converter 140 or its half bridges are not required in an actively acting manner here. A current I_{DC} flows from the DC voltage source 178.2 directly to the battery 150. This means that the battery can be charged directly with 800 V DC voltage, for example. Energy could also be transferred from the battery to the DC voltage source 178.2. It should be noted that no external DC voltage system should be connected to the first DC voltage charging terminals.

1. Electrical machine unit (160) with an electrical machine (130, 130b, 130c) and with a power converter (140),
wherein the electrical machine (130) comprises a plurality of phases (U, V, W) each having a regular phase winding (136U, 136V, 136W) and an additional inductance (136X), wherein the plurality of regular phase windings are connected together at a neutral point (138), and wherein the additional inductance (136X) is connected to at least one of the plurality of regular phase windings,
wherein the power converter (140) comprises a plurality of half-bridges (144U, 144V, 144W), each of the plurality of half-bridges being connected, at a center tap (145U, 145V, 145W) of the respective half-bridge, to one of the plurality of regular phase windings of the electrical machine,
wherein the electrical machine unit (160), in particular the power converter, has DC voltage terminals (B+, B−), which are set up for connection to an energy storage (150), and DC side switches (180+, 180−),
wherein DC side terminals (146+, 146−) of the plurality of half-bridges are each connected to one another and each be connectable to a respective one of the DC voltage terminals (B+, B−) via one of the DC side switches (180+, 180−) in a closed state of the switches or be disconnectable therefrom in an open state of the switches,
wherein the electrical machine unit (160) comprises first DC charging terminals (172.1+, 172.1−), wherein the additional inductance (136X) is connected or connectable to one of the first DC charging terminals, wherein one side of the DC side terminals (146−) of the plurality of half-bridges is connected or connectable to another of the first DC charging terminals,
wherein the electrical machine unit (160) comprises second DC charging terminals (172.2+, 172.2−), the DC side terminals of the plurality of half-bridges being connected or connectable to a respective one of the second DC charging terminals.

2. Electrical machine unit (160) according to claim 1, wherein the additional inductance (136X) is connected to the neutral point (138) and via it to the plurality of regular phase windings (136U, 136V, 136W).

3. Electrical machine unit (160) according to claim 1, wherein the additional inductance (136X) is connected to one of the plurality of regular phase windings on a side of said regular phase winding opposite to the neutral point.

4. Electrical machine unit (160) according to claim 1, wherein the additional inductance is inductively coupled to at least one of the plurality of regular phase windings.

5. Electrical machine unit (160) according to claim 4, wherein the additional inductance is directly inductively coupled to at least one of the plurality of regular phase windings.

6. Electrical machine unit (160) according to claim 4, wherein the additional inductance is inversely inductively coupled to at least one of the plurality of regular phase windings.

7. Electrical machine unit (160) according to claim 1, wherein the electrical machine comprises a stator, wherein the additional inductance is formed as an additional winding, and wherein the plurality of regular phase windings and the additional winding are arranged in the stator.

8. Electrical machine unit (160) according to claim 1, wherein the electrical machine comprises three phases with three regular phase windings.

9. Electrical machine unit (160) according to claim 1, wherein the power converter (140) is bidirectional.

10. Electrical machine unit (160) according to claim 1, which is configured as a traction drive of a vehicle (100).

11. Vehicle (100) having an electrical machine unit (160) according to claim 1 and having an energy storage (150), in particular a battery, the energy storage being connected to the DC voltage terminals (B+, B−).

12. Method of operating an electrical machine unit (160) according to claim 1,
wherein the power converter (140) and/or the DC side switches (180+, 180−) are controlled depending on an operating mode.

13. Method according to claim 12, wherein for operation, in particular motor and/or generator operation, of the electrical machine (130) the DC side switches are controlled to assume the closed state, and
wherein the power converter is controlled to convert the current between DC and AC voltage.

14. Method according to claim 12, wherein for energy transfer between a connected energy storage (150) and an external DC voltage system (178.1) to be connected or connected via the first DC charging terminals, the DC side switches are actuated to assume the closed state, and
wherein the power converter (140) is controlled to convert a DC voltage between a first voltage level between the first DC charging terminals and a second voltage level of the energy storage.

15. Method according to claim 12, wherein for energy transfer between an external DC voltage system (178.1) to be connected or connected to the first DC charging terminals and a further external DC voltage system (178.2) to be connected or connected to the second DC voltage charging terminals, the DC side switches are controlled to assume the open state, and
wherein the power converter (140) is controlled to convert a DC voltage between a first voltage level between the first DC charging terminals and a second voltage level between the second DC charging terminals.

16. Method according to claim 12, wherein for energy transfer between a connected energy storage (150) and an external DC voltage system (178.2) to be connected or connected via the second DC charging terminals, the DC side switches are controlled to assume the closed state.
